(19) United States
(12) Patent Application Publication
(10) Pub. No.: US 2016/0292380 A1
(43) Pub. Date: Oct. 6, 2016

(54) DEVICE AND METHOD FOR PREDICTING SKIN AGE BY USING QUANTIFYING MEANS

(71) Applicant: AMOREPACIFIC CORPORATION, Yongsan-gu, Seoul (KR)

(72) Inventors: Ga Young CHO, Yongin-si (KR); Jee Yeun KIM, Yongin-si (KR); Myeong Hun YEOM, Yongin-si (KR); Jun Cheol CHO, Yongin-si (KR)

(73) Assignee: Amorepacific Corporation, Seoul (KR)

(21) Appl. No.: 15/037,636

(22) PCT Filed: Nov. 21, 2014
(86) PCT No.: PCT/KR2014/011271

§ 371 Date: May 18, 2016

(30) Foreign Application Priority Data
Nov. 22, 2013 (KR) 10-2013-0142938

(51) Int. Cl. G06F 19/00; G06F 7/483

(52) U.S. Cl. CPC G06F 19/3431; G06F 7/483

(57) ABSTRACT

A device and a method for predicting skin age of a human by using a statistical quantifying means are provided. The method for predicting skin age, according to the present invention, comprises a step of calculating a skin age rating by substituting at least one related factor indicative of a skin condition of a subject to a skin age prediction equation, wherein the skin age prediction equation is formed by a linear combination of a regression constant and at least one variable term respectively corresponding to the at least one related factor.

### TECHNICAL FIELD

This disclosure relates to a device and method for predicting skin age, and more particularly, to a device and method for predicting skin age of a human by using a statistical quantifying means.

### BACKGROUND ART

The skin of a human is aged along with the passing of time and due to environmental factors. The skin aging of a human has wide variations in persons, and thus persons of the same biological age may have different degrees of skin aging.

According to skin experts such as dermatologists and oriental medicines, a skin condition of a human may be judged based on expanded visual features as well as length, width and thickness of skin wrinkles. Based on such visual features and personal experiments, specialists infer a skin condition by using an abstractive concept of skin age. The skin age is more seriously influenced by apparent skin features or the degree of skin aging of a subject, rather than biological age.

Meanwhile, the skin age may be differently judged according to subjective feeling of an observer who observes the skin of the subject, and there is established no objective standards for discriminating skin age. For this reason, it is difficult to quantify skin age. In other words, even though it may be relatively easy to comparatively evaluate skin age of different subjects by comparing them with each other, but it is not easy to objectively and quantitatively evaluate skin age of a subject individually without specialized analysis of experts.

### DISCLOSURE

### Technical Problem

This disclosure is directed to providing a device and method for predicting skin age of a human by using a statistical quantifying means.

This disclosure is also directed to providing a device and method for quantitatively evaluating skin age of a human without specialized analysis of experts.

This disclosure is also directed to providing a device and method for predicting skin age of a subject to propose a cosmetic product suitable for the subject.

### Technical Solution

In one general aspect, there is provided a method for predicting skin age, comprising: calculating a skin age rating by substituting at least one related factor indicative of a skin condition of a subject to a skin age prediction equation, wherein the skin age prediction equation is formed by a linear combination of a regression constant and at least one variable term respectively corresponding to the at least one related factor.

In an embodiment, the method may further include measuring or receiving the at least one related factor.

In an embodiment, the method may further include determining skin age of the subject from the calculated skin age rating.

In an embodiment, the determining of skin age of the subject may include: scaling the calculated skin age rating according to a predetermined manner; and calculating skin age of the subject by using the scaling result.

In an embodiment, the related factor may include a pigment area and a periorbital wrinkle area of the subject.

In an embodiment, the skin age prediction equation may be determined by: performing correlation analysis to a plurality of samples to determine at least one related factor among a plurality of factors indicative of a skin condition of a human; performing multiple regression analysis to the plurality of samples with respect to the determined related factor to determine a regression constant and at least one variable term; and performing linear combination to the determined regression constant and the at least one variable term.

In an embodiment, the at least one variable term may be respectively expressed by a multiply of a variable corresponding to any one of the pigment area and the periorbital wrinkle area and a beta index corresponding to the variable.

In an embodiment, the skin age prediction equation may be express as: Q19=7.414 0.0000558×X1−0.0000576×X2, wherein Q19 is the skin age rating, wherein X1 is a variable corresponding to the pigment area, wherein X2 is a variable corresponding to the periorbital wrinkle area, wherein 7.414 is the regression constant, and wherein −0.0000558 and −0.0000576 are beta indexes respectively corresponding to X1 and X2.

In another aspect of the present disclosure, there is provided a device for predicting skin age, comprising: a storage unit configured to store a skin age prediction equation; and a processor configured to calculate a skin age rating by putting at least one related factor indicative of a skin condition of a subject to the stored skin age prediction equation, wherein the skin age prediction equation is formed by a linear combination of a regression constant and at least one variable term respectively corresponding to the at least one related factor.

In an embodiment, the device may further include a measuring unit configured to measure the at least one related factor.

### Advantageous Effects

According to embodiments of the present disclosure, it is possible to predict skin age of a human by using a statistical quantifying means.

In addition, the skin age of a human may be quantitatively evaluated in an easy way without specialized analysis of experts.

Moreover, by predicting skin age of a subject, it is possible to propose a cosmetic product suitable for the subject.

### DESCRIPTION OF DRAWINGS

FIG. 1 is a diagram showing a correlation between skin age and real age of a human.

FIG. 2 is a bar graph in which samples having the same average real age are classified into different groups according to skin age.

FIG. 3 is a bar graph showing skin age of samples classified into five ratings according to evaluation of experts.

FIG. 4 is a table showing a result of correlation analysis for determining a related factor according to an embodiment of the present disclosure.

FIG. 5 is a table showing a result of multiple regression analysis, which is indicative of an influence of the related factor to skin age according to an embodiment of the present disclosure.

FIG. 6 is a flowchart for illustrating a method of determining a skin age prediction equation according to an embodiment of the present disclosure.

FIG. 7 is a flowchart for illustrating a method for predicting skin age according to an embodiment of the present disclosure.

### BEST MODE

The following detailed description of the present disclosure refers to the accompanying drawings which show specific embodiments implemented by the present disclosure. These embodiments are described in detail so as to be easily implemented by those skilled in the art. It should be understood that various embodiments of the present disclosure are different from each other but not exclusive from each other. For example, specific shapes, structures and features written herein can be implemented in other embodiments without departing from the scope of the present disclosure.

In addition, it should be understood that locations or arrangements of individual components in each embodiment may be changed without departing from the scope of the present disclosure. Therefore, the following detailed description is not directed to limiting the present disclosure, and the scope of the present disclosure is defined just with the appended claims along and their equivalents, if it is suitably explained. In the drawings, like reference numerals denote like elements through several drawings.

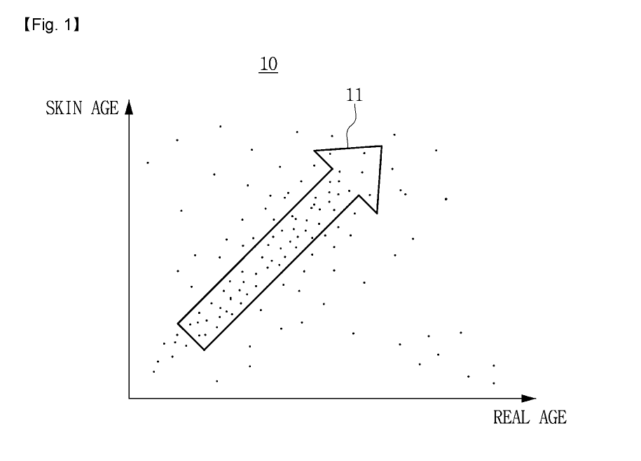

FIG. 1 is a diagram showing a correlation between skin age and real age of a human. Referring to FIG. 1, real age and skin age of samples (persons participating in experiments or measurements) are depicted as dots on a two-dimensional plane. In this specification, skin age of the samples is measured by means of visual evaluation of experts and questionnaire assessment.

In FIG. 1, the skin age of the samples generally increases as the real age increases (11). Nevertheless, as shown from samples located at a lower right side of the FIG. 10 and samples located at an upper left side of the FIG. 10, the skin age of the samples is not always proportional to the real age. This is because skin age of a human is influenced by both endogenous factors such as natural aging according to the passing of time and environmental factors such as aging caused by skin-exposed environments, skin management habits or the like.

Therefore, a person is not able to exactly figure out his/her skin age just with biological real age. In addition, in general cases, such skin age may be accurately diagnosed to some extent just through visual evaluation of an expert, but even the expert visual evaluation may give different determination results due to subjective feeling of the expert. The present disclosure provides a means for quantifying of persons and objectively predicting skin age, so that the skin age may be predicted more simply and more objectively.

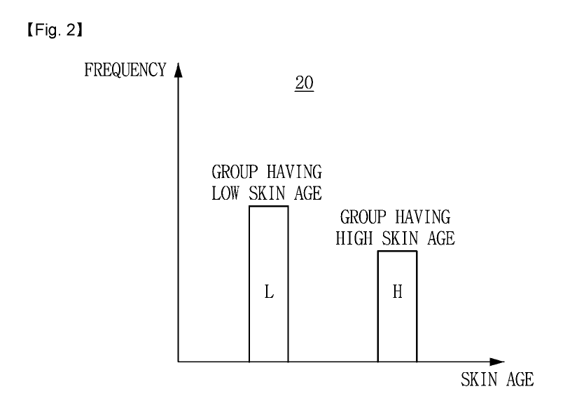

FIG. 2 is a bar graph in which samples having the same average real age are classified into different groups according to skin age. Referring to FIG. 2, samples having the same average real age are classified into a group H having high skin age and a group L having low skin age and depicted with a bar graph 20.

In an embodiment of the present disclosure, in order to determine factors having an influence on skin age (hereinafter, related factors), first, samples having the same average real age are classified into different groups depending on skin age, through expert visual evaluation and questionnaire assessment. In addition, various factors related to skin conditions of the samples are measured, and correlations between the measured factors and the skin age are analyzed to determine related factors directly related to the skin age.

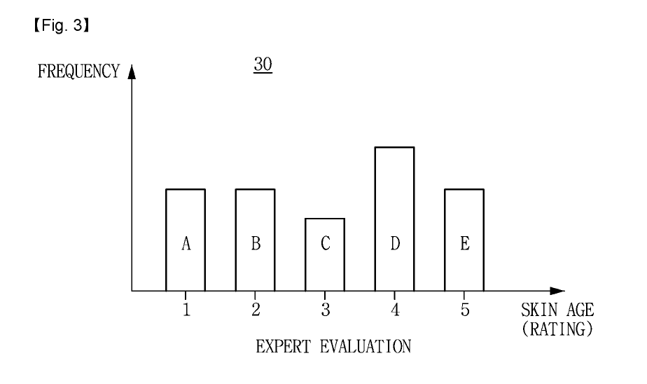

In order to analyze correlations between the factors and the skin age, a correlation analysis which is a general statistical method is used. If related factors are determined with respect to samples having the same average real age as shown in FIG. 3, the influence of endogenous factors may be minimized, and thus related factors may be determined based on environmental factors more intensively.

FIG. 3 is a bar graph showing skin age of samples classified into five ratings according to evaluation of experts. Referring to FIG. 3, the skin age of the samples is classified into five ratings by experts and depicted as a bar graph 30.

In this embodiment, experts evaluate skin age of samples just from skin conditions of the samples in a state where real age of the samples is blind. Skin age groups A, B, C, D, E according to the expert evaluation are classified into 1 to 5 ratings.

In an embodiment, a group A evaluated as a 1 rating is a group in which skin age is evaluated to be less than 35 by means of expert evaluation. A group B evaluated as a 2 rating is a group in which skin age is evaluated to be 35 to 41 by means of expert evaluation. A group C evaluated as a 3 rating is a group in which skin age is evaluated to be 42 to 48 by means of expert evaluation. A group D evaluated as a 4 rating is a group in which skin age is evaluated to be 49 to 55 by means of expert evaluation. A group E evaluated as a 5 rating is a group in which skin age is evaluated be equal to be equal to or higher than 56.

However, this skin age classification standard is just an example, and in the present disclosure, skin age of samples may also be classified based on other classification standards. For example, in the present disclosure, samples may be classified into 10 groups with the same interval or the same magnitude based on skin age from 1 to 100.

In this embodiment, samples are not demanded to have the same average real age, and experts evaluate skin age of the samples just with the observed skin conditions. The skin age evaluation result of the experts has been checked as having no significant difference by means of one-way variance analysis, and by doing so, the evaluation result ensures objectivity.

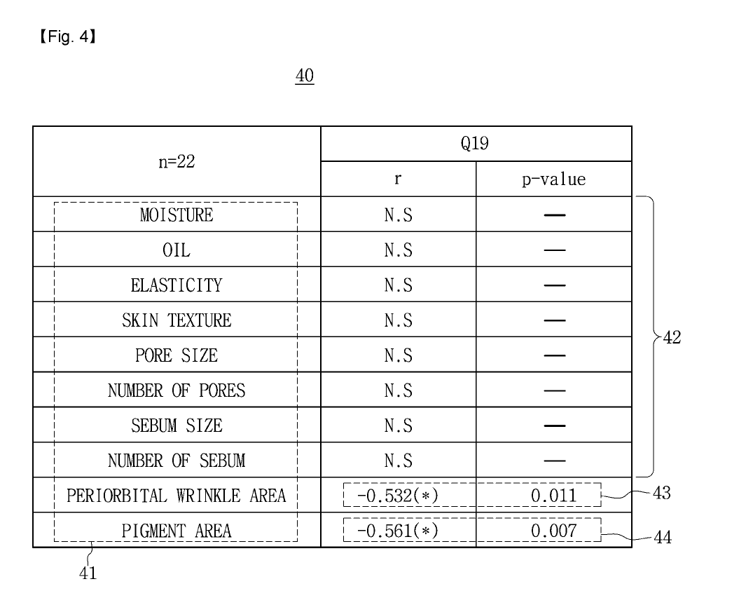

Meanwhile, in this embodiment, similar to FIG. 2, in order to determine factors giving an influence on skin age, various factors related to skin conditions of the samples are measured, and correlations between the measured factors and the skin age are analyzed to determine related factors directly related to the skin age. In order to analyze correlations between the factors and the skin age, a correlation analysis which is a general statistical method is used. A detailed example of the correlation analysis employed in this embodiment will be described below with reference to FIG. 4.

FIG. 4 is a table showing a result of correlation analysis for determining a related factor according to an embodiment of the present disclosure. Referring to FIG. 4, a table 40 includes factors 41 indicating skin conditions and their correlation analysis results.

In FIG. 4, n represents a total number of samples, r represents a correlation coefficient calculated according to the correlation analysis, p-value represents significant probability, and Q19 represents an expert evaluation result. Here, Q19 is an expert evaluation result, which may correspond to values of 1 to 5 if the skin age is 1 to 5 ratings (namely, Q19 of the group A in FIG. 3 is 1). Meanwhile, in the table 40, * represents significance in the level of 0.05 in 2-tailed analysis, and ** represents significance in the level of 0.01 in 2-tailed analysis.

In FIG. 4, the table 40 shows correlations between the factors 41 and the Q19. In detail, the correlation coefficient r has a value of −1 to 1 and represents a linear relationship between the factors 41 and the Q19.

For example, if r<−0.7, this means that the factor and the Q19 have strong negative linear relationship; if −0.7<r<−0.3, this means that the factor and the Q19 have noticeable negative linear relationship to some extent; and if −0.3<r<−0.1, this means that the factor and the Q19 have weak negative linear relationship. Meanwhile, if 0.7<r, this means that the factor and the Q19 have strong negative linear relationship; if 0.3<r<0.7, this means that the factor and the Q19 have noticeable negative linear relationship to some extent; and if 0.1<r<0.3, this means that the factor and the Q19 have weak negative linear relationship. If −0.1<r<0.1, it is regarded that the factor ad the Q19 have no significant linear relationship (N.S).

In FIG. 4, most of the factors 41 (moisture, oil, elasticity, skin texture, pore size, the number of pore, sebum size, the number of sebum) have been analyzed as having no significant correlation (N.S) with the Q19 representing skin age (42). In addition, in the factors 41, a periorbital wrinkle area and a pigment area have been analyzed as having significant correlations with the Q19 (43, 44).

A correlation coefficient r between the periorbital wrinkle area and the Q19 is −0.532 (with a significance level of 0.05), and at this time, significance probability is 0.011 (43). A correlation coefficient r between the pigment area and the Q19 is −0.561 (with a significance level of 0.01), and at this time, significance probability is 0.007 (44). Factors (a periorbital wrinkle area and a pigment area) analyzed as having a correlation with the Q19 becomes related factor in the present disclosure. However, the related factors determined herein are just examples, and other factors (for example, skin texture) not described herein may also be added as related factors.

Meanwhile, in this embodiment, the measurement values of the factors 41 used in the correlation analysis (or, multiple regression analysis, described later) may not represent an absolute number, content or area. Specifically, the measurement values of the factors 41 may be a relative value obtained by scaling an absolute number, content or area, which is a processed value proportional to an absolute number, content or area. For example, when a measurement value of the periorbital wrinkle area used in this embodiment is 30, this does not mean an absolute area such as 30 mm² or 30 cm² but means that an area has a relative size of 30. In other words, the measurement value of 30 may mean 10 mm². However, at this time, since the measurement value is proportional to the absolute area, if the measurement value increases doubly from 30 to 60, this means that the absolute area also increases doubly.

In an embodiment, in order to measure a periorbital wrinkle area and a pigment area, a predetermined skin condition measuring means may be used. The skin condition measuring means may employ the Skin Touch System (STS), used in Amore-Pacific Corporation. The Skin Touch System measures a skin condition by using an AP scope and an AP sensor. Here, the AP scope is a scope for magnification photograph, which may show a skin of a subject as an enlarged view, and 30 magnifying lenses are mounted thereto. The AP scope may obtain a skin image in two forms of a general mode and a polarization mode by using a left lever.

In an embodiment, the periorbital wrinkle area may be measured by photographing a wrinkle portion with sufficient magnification, then calculating the area of each wrinkle by means of conversion from a 2D image to a 3D image, and calculating an area of all wrinkles accordingly.

In an embodiment, the pigment area may be measured by photographing a skin surface in a polarization mode, separating a pigmentation region separately from the photographed skin image, and then calculating an area of the pigmentation region.

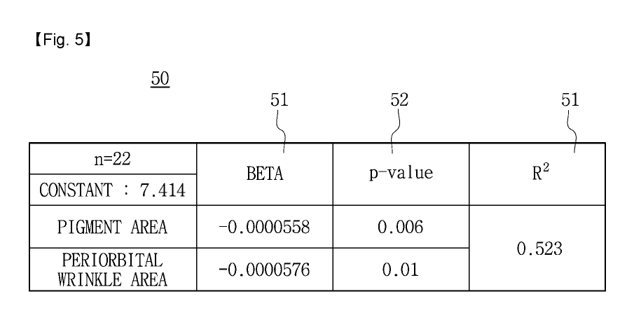

FIG. 5 is a table showing a result of multiple regression analysis, which is indicative of an influence of the related factor to skin age according to an embodiment of the present disclosure. Referring to FIG. 5, a table 50 shows related factors (a pigment area and a periorbital wrinkle area) and multiple regression analysis results thereof.

In FIG. 5, multiple regression analysis is used for statistically objectifying and materializing the influence of the related factors on Q19. In the table 50, n represents a total number of samples, a constant is a regression constant of a regression equation (or, a Y-intercept of the regression graph) representing a linear relationship between the related factor and the Q19, beta is a beta index of the regression equation (or, a slope of the regression graph), p-value is significant probability of the simple regression analysis, and R² is a determination coefficient of the regression equation (or, a determination coefficient of the regression graph). Here, the determination coefficient R² is a value representing a variable ratio between the related factors and the Q19, and as the determination coefficient is greater, the regression relationship between the related factors and the Q19 becomes more closer to linear relationship,

Referring to the table 50, as a result of the regression analysis, it has been revealed that the pigment area and the periorbital wrinkle area give influences on the significance level with respect to the Q19, and the skin age prediction equation (or, the multiple regression analysis model) configured according to the analysis result of the table 50 is as in Equation 1 below.

Q19=7.414−0.0000558×X1−0.0000576×X2 [Equation 1]

However, here, Q19 is skin age by expert evaluation, X1 is a measured pigment area, X2 is a measured periorbital wrinkle area, 7.414 is a determined regression constant, and −0.0000558 and −0.0000576 are respectively beta indexes of the pigment area and the periorbital wrinkle area.

In this embodiment, the measured pigment area and the measured periorbital wrinkle area are respectively substituted with variables (X1, X2) of the skin age prediction equation (Equation 1). The substitution result is calculated as Q19, and the calculated value means a value identical to skin age evaluated by experts within a significant level. If this method is used, even though expert evaluation is not performed, it is possible to calculate a result value substantially identical to an expert evaluation result within a significant level.

Meanwhile, since the skin age is designed to have a value of 1 to 5 by means of expert evaluation as described above, Q19 calculated by Equation 1 also generally has a value of 1 to 5. For example, if the calculated value of Q19 is 2, skin age of the subject belongs to the 1 rating, and the skin age corresponds to ages of 35 to 41.

In an embodiment, from this, the calculated Q19 may be scaled to calculate concrete skin age of the subject. For example, if the calculated Q19 has a value of 2, this means that the skin age of the subject belongs to the 1 rating and also the skin age is between 35 and 41. At this time, since the ratings have an interval of 7, if a value obtained by subtracting ½ of the rating interval from the upper limit of the 1 rating (namely, 31.5) is defined as a representative value of the 1 rating (namely, 31.5), a value obtained by subtracting 1 from the calculated Q19 is scaled seven times and then the representative value of the 1 rating is added as a reference value (7×(2−1)+31.5), thereby calculating that the skin age is 38.5 corresponding to the Q19 of 2. The calculated age of 38.5 is a medium value of the 2 rating. However, this scaling method is just an example, and various scaling methods other than the above may also be applied within the scope of the present disclosure. According to the present disclosure as described above, skin age of a human may be predicted using the statistical quantifying means, and skin age of a human may be easily quantified and evaluated without specialized analysis of an expert. Further, by predicting skin age of a subject through the above method, it is possible to obtain basic information for proposing cosmetic products suitable for the skin of the subject.

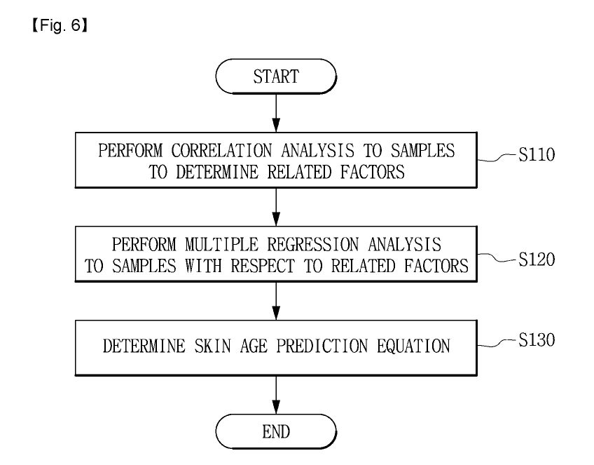

FIG. 6 is a flowchart for illustrating a method of determining a skin age prediction equation according to an embodiment of the present disclosure. Referring to FIG. 6, the method for determining a prediction equation includes the steps of S110 to S130.

In S110, correlation analysis is performed to samples to determine related factors. In detail, various factor values are measured from skin conditions of the samples, and correlation analysis is performed to the measured values and the skin age of the samples to determine related factors giving an influence on the skin age. A detailed method for determining related factors is as illustrated in FIGS. 4 and 5, and in embodiments of the present disclosure, the related factors are analyzed as a pigment area and a periorbital wrinkle area.

In S120, multiple regression analysis is performed to the samples with respect to the determined related factors, thereby determining the degree of influence of the related factors on the skin age in detail. The multiple regression analysis for the related factors have already described above with reference to FIGS. 4 and 5.

In S130, a skin age prediction equation is determined according to the result of the multiple regression analysis. The determined skin age prediction equation is as in Equation 1 described above, and the prediction equation is composed of a linear combination of a regression constant according to the multiple regression analysis and a measured pigment area and periorbital wrinkle area respectively multiplied by its beta index.

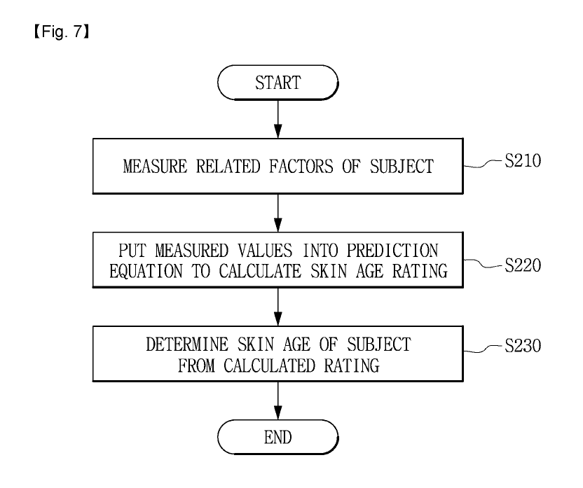

FIG. 7 is a flowchart for illustrating a method for predicting skin age according to an embodiment of the present disclosure. Referring to FIG. 7, the method for predicting skin age includes the steps of S210 to S230.

In this embodiment, a prediction equation for predicting skin age is assumed as being predetermined by the method of FIG. 6.

In this embodiment, the method for predicting skin age may be performed by at least one computing device. The computing device may include a storage unit configured to store an algorithm representing a skin age prediction equation or a prediction equation, and a processor configured to calculate skin age by putting measurement values of related factors to the prediction equation or algorithm. In an embodiment, the computing device may further include a measuring unit configured to measure related factors of a subject. A general computing device configured to store data and drive a predetermined algorithm with reference to the stored data is already well known in the art and thus is not described in detail here.

In S210, related factors of a subject are measured. In an embodiment, the related factors may be a pigment area and a periorbital wrinkle area.

In S220, the measured related factors are put into a skin age prediction equation to calculate a skin age rating. For example, the pigment area is substituted with X1 of Equation 1 and the periorbital wrinkle area is substituted with X2 of Equation 1, and the substitution result Q19 becomes a skin age rating of the subject. The calculated skin age rating may be a predetermined rating indicative of skin age of the subject or a value obtained by directly weighing the skin age of the subject.

In S230, concrete skin age of the subject is determined from the calculated skin age rating. In an embodiment, the method for predicting skin age may scale the calculated skin age rating according to a predetermined manner to determine skin age of the subject. A detailed method or example for scaling a skin age rating is already described above with reference to FIG. 5.

If the method for predicting skin age according to the present disclosure as described above is used, skin age of a human may be predicted by using a statistical quantifying means, and the skin age of a human may be quantitatively evaluated in an easy way without specialized analysis of experts. Moreover, by predicting skin age of a subject through the proposed method, it is possible to obtain basic information for suggesting cosmetic products suitable for the skin of the subject.

While the exemplary embodiments have been shown and described herein, each embodiment may be modified in various ways without departing from the scope of the present disclosure.

In addition, through specific terms have been used herein, they are used just for explaining the present disclosure and are not intended to limit the meaning or scope of the present disclosure, defined in the claims. Therefore, the scope of the present disclosure should not be limited to the above embodiments but be defined by the appended claims and their equivalents.

1. A method for predicting skin age, comprising:
calculating a skin age rating by substituting at least one related factor indicative of a skin condition of a subject to a skin age prediction equation,
wherein the skin age prediction equation is formed by a linear combination of a regression constant and at least one variable term respectively corresponding to the at least one related factor.

2. The method for predicting skin age according to claim 1, further comprising:
measuring or receiving the at least one related factor.

3. The method for predicting skin age according to claim 1,
wherein the related factor includes a pigment area and a periorbital wrinkle area of the subject.

4. The method for predicting skin age according to claim 3,
wherein the skin age prediction equation is determined by:
performing correlation analysis to a plurality of samples to determine at least one related factor among a plurality of factors indicative of a skin condition of a human;
performing multiple regression analysis to the plurality of samples with respect to the determined related factor to determine a regression constant and at least one variable term; and
performing linear combination to the determined regression constant and the at least one variable term.

5. The method for predicting skin age according to claim 4,
wherein the at least one variable term is respectively expressed by a multiply of a variable corresponding to any one of the pigment area and the periorbital wrinkle area and a beta index corresponding to the variable.

6. The method for predicting skin age according to claim 5,
wherein the skin age prediction equation is express as:
Q19=7.414−0.0000558×X1−0.0000576×X2,
wherein Q19 is the skin age rating,
wherein X1 is a variable corresponding to the pigment area,
wherein X2 is a variable corresponding to the periorbital wrinkle area,
wherein 7.414 is the regression constant, and
wherein −0.0000558 and −0.0000576 are beta indexes respectively corresponding to X1 and X2.

7. The method for predicting skin age according to claim 1, further comprising:
determining skin age of the subject from the calculated skin age rating.

8. The method for predicting skin age according to claim 7,
wherein the determining of skin age of the subject includes:
scaling the calculated skin age rating according to a predetermined manner; and
calculating skin age of the subject by using the scaling result.

9. A device for predicting skin age, comprising:
a storage unit configured to store a skin age prediction equation; and
a processor configured to calculate a skin age rating by putting at least one related factor indicative of a skin condition of a subject to the stored skin age prediction equation,
wherein the skin age prediction equation is formed by a linear combination of a regression constant and at least one variable term respectively corresponding to the at least one related factor.

10. The device for predicting skin age according to claim 9, further comprising:
a measuring unit configured to measure the at least one related factor.
